(19) United States
(12) Patent Application Publication
(10) Pub. No.: US 2026/0100464 A1
(43) Pub. Date: Apr. 9, 2026

(54) ENERGY STORAGE DEVICE

(71) Applicant: TOYOTA JIDOSHA KABUSHIKI KAISHA, Toyota-shi (JP)

(72) Inventor: Junta TAKASU, Nagoya-shi (JP)

(73) Assignee: TOYOTA JIDOSHA KABUSHIKI KAISHA, Toyota-shi (JP)

(21) Appl. No.: 19/276,527

(22) Filed: Jul. 22, 2025

(30) Foreign Application Priority Data
Oct. 7, 2024 (JP) 2024-175781

(51) Int. Cl. H01M 50/258; H01M 4/02; H01M 10/6555; H01M 10/6556

(52) U.S. Cl. CPC H01M 50/258; H01M 10/6555; H01M 10/6556; H01M 2004/029

(57) ABSTRACT

An energy storage device includes at least one energy storage module and a case. Each of the at least one energy storage module includes a plurality of electrode sheets including a bipolar electrode sheet, and a sealant. The bipolar electrode sheet includes a current collector foil, a cathode active material layer, and an anode active material layer. Each of the end faces of the energy storage module in a first direction includes an electrode-facing region and a non-electrode-facing region. In each of the end faces of the energy storage module in the first direction, at least part of the non-electrode-facing region is bonded to another adjacent energy storage module or the case via an adhesive.

### CROSS-REFERENCE TO RELATED APPLICATION

This application claims priority to Japanese Patent Application No. 2024-175781 filed on Oct. 7, 2024. The disclosure of the above-identified application, including the specification, drawings, and claims, is incorporated by reference herein in its entirety.

### BACKGROUND

### 1. Technical Field

The technique disclosed in the present specification relates to energy storage devices.

### 2. Description of Related Art

Japanese Unexamined Patent Application Publication No. 2024-002627 (JP 2024-002627 A) describes an energy storage device. The energy storage device includes at least one energy storage module stacked in a first direction. Each of the at least one energy storage module includes a plurality of electrode sheets stacked in the first direction and including a bipolar electrode sheet, and a sealant disposed at the periphery of the electrode sheets and sealing an electrolyte between the electrode sheets. The bipolar electrode sheet includes a current collector foil, a cathode active material layer provided on one surface of the current collector foil, and an anode active material layer provided on the other surface of the current collector foil. Each of the end faces of the energy storage module in the stacking direction includes an electrode-facing region and a non-electrode-facing region when viewed in the first direction. The electrode-facing region faces either or both of the cathode active material layer and the anode active material layer. The non-electrode-facing region is located outward of the electrode-facing region and inward of the sealant.

### SUMMARY

One possible way to restrain such an energy storage module in the first direction (that is, the stacking direction) is to restrain the region excluding the electrode-facing region. However, the electrode-facing region is present over a relatively wide area on each of the end faces of the energy storage module in the stacking direction. Therefore, it is not possible to sufficiently restrain the energy storage module by merely restraining the region excluding the electrode-facing region. One possible solution to avoid such an issue is to reduce the pressure in the energy storage module to a pressure lower than the atmospheric pressure. In this case, the non-electrode-facing region of each end face of the energy storage module in the stacking direction may be recessed toward the inside of the energy storage module due to the pressure difference between the inside and outside of the energy storage module.

In view of the above circumstances, the present specification provides a technique for avoiding or reducing the possibility that a non-electrode-facing region may be recessed toward the inside of an energy storage module in a first direction even when the pressure in the energy storage module is reduced to a pressure lower than the atmospheric pressure.

According to a first aspect of the present disclosure, an energy storage device includes: at least one energy storage module stacked in a first direction; and a case that houses the at least one energy storage module. Each of the at least one energy storage module includes a plurality of electrode sheets stacked in the first direction and including a bipolar electrode sheet, and a sealant disposed at the periphery of the electrode sheets and sealing an electrolyte between the electrode sheets. The bipolar electrode sheet includes a current collector foil, a cathode active material layer provided on one surface of the current collector foil, and an anode active material layer provided on another surface of the current collector foil. Each of end faces of the energy storage module in the first direction includes an electrode-facing region and a non-electrode-facing region. The electrode-facing region faces either or both of the cathode active material layer and the anode active material layer when viewed in the first direction. The non-electrode-facing region is located outward of the electrode-facing region and inward of the sealant when viewed in the first direction. In each of the end faces of the energy storage module in the first direction, at least part of the non-electrode-facing region is bonded to another adjacent energy storage module or the case via an adhesive.

In the above energy storage device, in each of the end faces of the energy storage module in the first direction, at least part of the non-electrode-facing region is bonded to another adjacent energy storage module or the case via the adhesive. As described above, the non-electrode-facing region of the energy storage module is bonded to another adjacent energy storage module or the case. This can avoid or reduce the possibility that the non-electrode-facing region may be recessed toward the inside of the energy storage module even when the pressure in the energy storage module is reduced to a pressure lower than the atmospheric pressure.

According to a second aspect, in the first aspect, in each of the end faces of the energy storage module in the first direction, a range of the non-electrode-facing region that includes the center line between the outer peripheral edge of the electrode-facing region and the inner peripheral edge of the sealant may be bonded to the other adjacent energy storage module or the case via the adhesive. When the pressure in the energy storage module is reduced, the non-electrode-facing region tends to be recessed toward the inside of the energy storage module in the range including the center line between the outer peripheral edge of the electrode-facing region and the inner peripheral edge of the sealant. The range including the center line is bonded to the other adjacent energy storage module or the case. This can effectively avoid or reduce the possibility that the non-electrode-facing region may be recessed toward the inside of the energy storage module even when the pressure in the energy storage module is reduced to a pressure lower than the atmospheric pressure.

According to a third aspect, in the first or second aspect, the energy storage device may further include at least one plate material stacked together with the at least one energy storage module in the first direction. In this case, each of the at least one plate material may be electrically conductive and may be in contact with the electrode-facing region of the end face of the energy storage module in the first direction. In this configuration, the end face of the energy storage module and the end face of the other adjacent energy storage module are electrically connected via the plate material. In this case, the adhesive is disposed around the plate material. Therefore, the thickness of the adhesive may be designed according to the thickness of the plate material.

According to a fourth aspect, in the third aspect, the plate material may be provided with a cooling channel through which a cooling medium flows. With this configuration, the plate material can cool the energy storage module.

According to a fifth aspect, in any one of the first to fourth aspects, the adhesive may include a base material in the form of a sheet, and an adhesive layer provided on each of both surfaces of the base material. With this configuration, the thickness of the base material and the thickness of the adhesive layer can be changed as appropriate according to the distance between the electrode-facing regions of two adjacent energy storage modules.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows the configuration of an energy storage device according to an embodiment;

FIG. 2 is a cross-sectional view taken along line II-II in FIG. 1;

FIG. 3 is an enlarged view of a portion III in FIG. 2; and

FIG. 4 illustrates the center line between the outer peripheral edge of an electrode-facing region and the inner peripheral edge of a sealant.

### DETAILED DESCRIPTION OF EMBODIMENTS

An energy storage device 10 of an embodiment will be described with reference to the drawings. The energy storage device 10 in the present embodiment is a bipolar lithium-ion secondary battery. The energy storage device 10 is mounted on a vehicle, for example, and can be used as a power source for driving wheels of the vehicle. In another embodiment, the energy storage device 10 may be a secondary battery (for example, a nickel-hydrogen secondary battery) other than the lithium-ion secondary battery. In still another embodiment, the energy storage device 10 may be an all-solid-state battery.

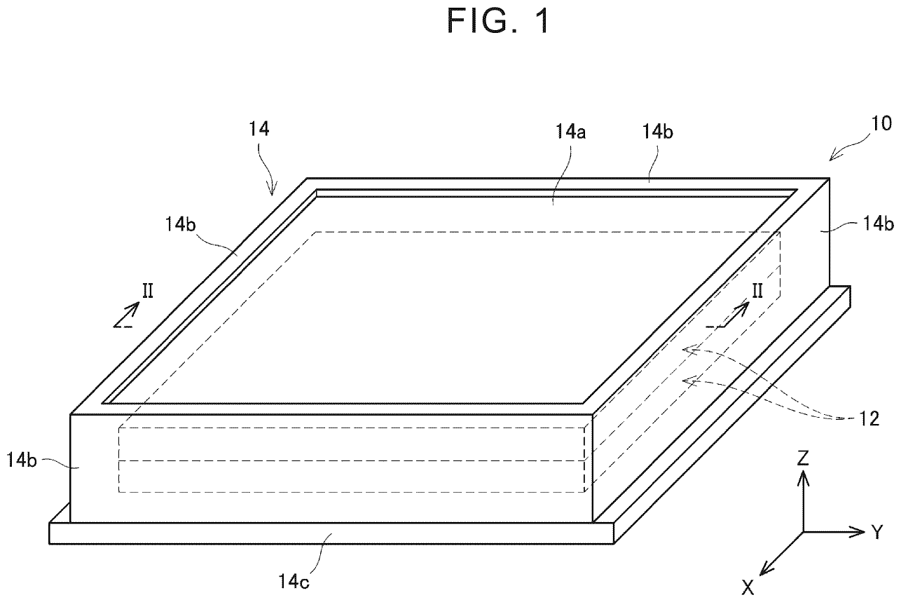

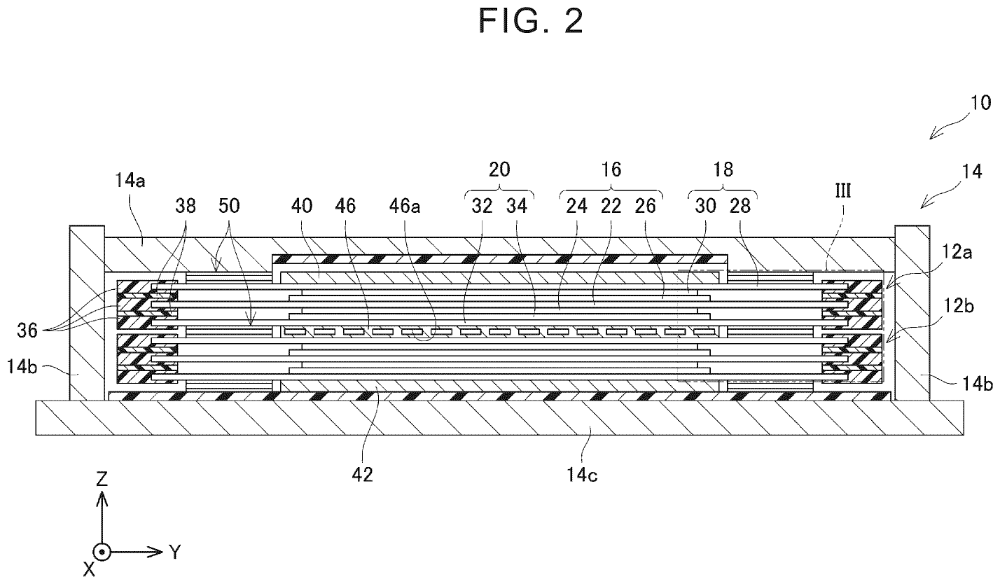

As illustrated in FIGS. 1 and 2, the energy storage device 10 includes a plurality of energy storage modules 12 and a case 14 that houses the energy storage modules 12.

As illustrated in FIGS. 2 to 4, the energy storage modules 12 includes two energy storage module 12a, 12b. The two energy storage modules 12a, 12b include a first energy storage module 12a and a second energy storage module 12b. Each of the two energy storage modules 12 is disposed parallel to the X axis and the Y axis. The two energy storage modules 12 are stacked in the Z-axis direction. That is, the first energy storage module 12a and the second energy storage module 12b are stacked in this order from the positive Z-axis direction toward the negative Z-axis direction. The X-axis, the Y-axis, and the Z-axis are orthogonal to each other.

As shown in FIGS. 1 and 2, the case 14 includes an upper wall 14a, four side walls 14b, and a lower wall 14c. Each of the upper wall 14a and the lower wall 14c is disposed parallel to the X-axis and the Y-axis. The upper wall 14a is disposed on the positive Z-axis direction side of the first energy storage module 12a, and the lower wall 14c is disposed on the negative Z-axis direction side of the second energy storage module 12b. Each of the four side walls 14b extends from the lower wall 14c toward the positive Z-axis direction.

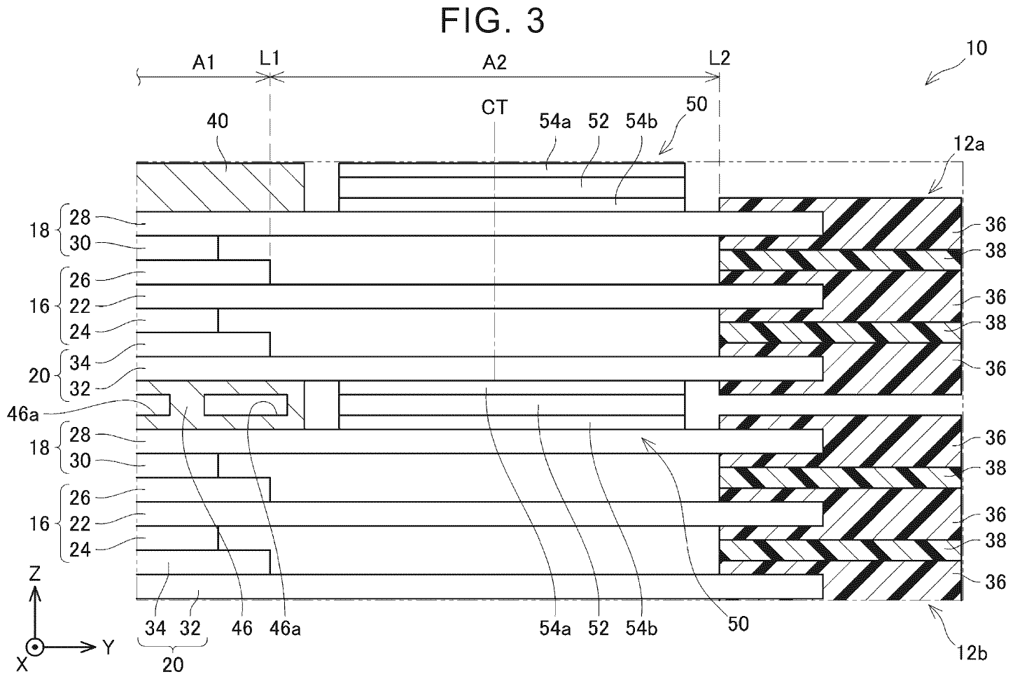

As illustrated in FIGS. 2 and 3, each of the two energy storage modules 12 includes a plurality of electrode sheets 16, 18, 20. Each of the electrode sheets 16, 18, 20 is disposed parallel to the X-axis and the Y-axis. The electrode sheets 16, 18, 20 are stacked in the Z-axis direction.

The electrode sheets 16, 18, 20 include a bipolar electrode sheet 16, a cathode-side end electrode sheet 18, and an anode-side end electrode sheet 20. The bipolar electrode sheet 16 is disposed between the cathode-side end electrode sheet 18 and the anode-side end electrode sheet 20.

The bipolar electrode sheet 16 includes a current collector foil 22, a cathode active material layer 24, and an anode active material layer 26. The current collector foil 22 is an electrically conductive sheet. The current collector foil 22 is, for example, a laminate 25 of a copper foil and an aluminum foil, and the aluminum foil is bonded to one surface of the copper foil. The cathode active material layer 24 is provided on one surface of the current collector foil 22 (i.e., a surface in the negative Z-axis direction). The anode active material layer 26 is provided on the other surface (i.e., the surface in the positive Z-axis direction) of the current collector foil 22.

The cathode active material layer 24 includes a cathode active material. Examples of the cathode active material include layered rock-salt active materials, spinel active materials such as lithium manganese oxides, and olivine active materials such as lithium iron phosphate (LFP) and lithium manganese iron phosphate (LMFP). Examples of the cathode active material include a lithium nickel-based composite oxide and a lithium cobalt-based composite oxide. Examples of the cathode active material include a lithium manganese-based composite oxide. Examples of the cathode active material include a lithium nickel manganese-based composite oxide (for example, LiNi_{1/2}Mn_{3/2}O₄). Examples of the cathode active material include a lithium nickel manganese cobalt-based composite oxide (for example, LiNi_{1/3}Mn_{1/3}Co_{1/3}O₂). The anode active material layer 26 includes an anode active material. Examples of the anode active material include carbon materials such as graphite, hard carbon, and soft carbon, and materials for forming an alloy with lithium such as silicon (Si). Examples of the anode active material include these lithium alloys (for example, Li_{X}M, where M is C, Si, Sn, Sb, Al, Mg, Ti, Bi, Ge, Pb, or P, and X is a natural number). Each active material may be made of a single material or a plurality of materials. Each of the active material layers 24, 26 may further include a conductive aid, a binder, etc.

The cathode-side end electrode sheet 18 includes a cathode-side end current collector foil 28 and a cathode-side end active material layer 30. The cathode-side end current collector foil 28 is an electrically conductive sheet. The cathode-side end current collector foil 28 is, for example, an aluminum foil. The cathode-side end active material layer 30 is provided on one surface of the cathode-side end current collector foil 28 (that is, the surface on the negative Z-axis direction side). The cathode-side end active material layer 30 faces the anode active material layer 26 of the bipolar electrode sheet 16.

The anode-side end electrode sheet 20 includes an anode-side end current collector foil 32 and an anode-side end active material layer 34. The anode-side end current collector foil 32 is an electrically conductive sheet. The anode-side end current collector foil 32 is, for example, a copper foil. The anode-side end active material layer 34 is provided on one surface of the anode-side end current collector foil 32 (that is, the surface on the positive Z-axis direction side). The anode-side end active material layer 34 faces the cathode active material layer 24 of the bipolar electrode sheet 16.

As shown in FIGS. 2 and 3, each of the two energy storage modules 12 further includes sealants 36, 38. The sealants 36, 38 have a frame shape. The sealants 36, 38 include a plurality of sheet materials 36 and a plurality of spacers 38. Each of the sheet materials 36 is disposed at the periphery of a corresponding one of the bipolar electrode sheet 16, the cathode-side end electrode sheet 18, and the anode-side end electrode sheet 20. Each of the plurality of spacers 38 is disposed at the periphery of one of the bipolar electrode sheet 16, the cathode-side end electrode sheet 18, and the anode-side end electrode sheet 20 between two sheet materials 36 adjacent to each other in the stacking direction (i.e., the Z-axis direction). As a result, the sealants 36, 38 can seal the electrolyte between the electrode sheets 16, 18, 20. Although not particularly limited, each energy storage module 12 may further include a separator disposed between the bipolar electrode sheet 16 and each of the end electrode sheets 18, 20.

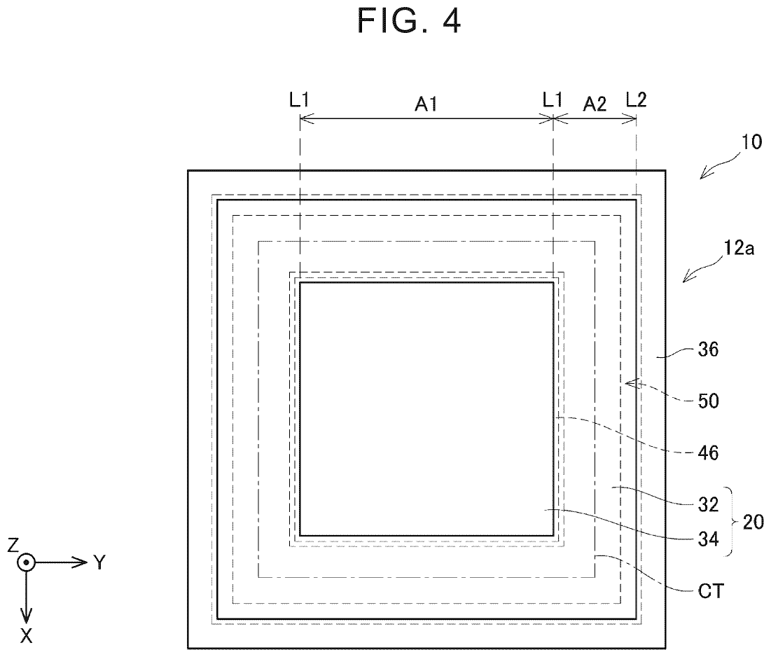

As shown in FIGS. 3 and 4, each end face of each energy storage module 12 in the stacking direction (that is, each of the surface on the positive Z-axis direction side of the cathode-side end current collector foil 28 and the surface on the negative Z-axis direction side of the anode-side end current collector foil 32) has an electrode-facing region A1 and a non-electrode-facing region A2. The electrode-facing region A1 faces either or both of the cathode active material layer 24 and the anode active material layer 26 when viewed in the stacking direction. The non-electrode-facing region A2 is located outward of the electrode-facing region A1 and inward of the sealants 36, 38 when viewed in the stacking direction.

As illustrated in FIGS. 2 and 3, the energy storage device 10 further includes two current collector terminals 40, 42. The two current collector terminals 40, 42 are electrically conductive. The two current collector terminals 40, 42 are stacked together with the two energy storage modules 12 in the Z-axis direction. Although not shown, a portion of each of the current collector terminals 40, 42 is exposed from the case 14 of the energy storage device 10, and the remainder of each of the current collector terminals 40, 42 is housed in the case 14 of the energy storage device 10. The two current collector terminals 40, 42 include a cathode-side current collector terminal 40 and an anode-side current collector terminal 42. The cathode-side current collector terminal 40 is in contact with the electrode-facing region A1 of the cathode-side end current collector foil 28 of the first energy storage module 12a. The anode-side current collector terminal 42 is in contact with the electrode-facing region A1 of the anode-side end current collector foil 32 of the second energy storage module 12b. Therefore, when an external device is attached to the two current collector terminals 40, 42, the two energy storage modules 12 and the external device are electrically connected to each other. Thus, power can be supplied from the energy storage device 10 to the external device, or the energy storage device 10 can be charged by the external device.

As illustrated in FIGS. 2 to 4, the energy storage device 10 further includes a cooling plate 46. The cooling plate 46 is stacked together with the two energy storage modules 12 in the Z-axis direction. The cooling plate 46 is provided with a cooling channel 46a through which a cooling medium (for example, air) flows. The cooling plate 46 is disposed between the first energy storage module 12a and the second energy storage module 12b. The cooling plate 46 is in contact with the electrode-facing region A1 of the anode-side end current collector foil 32 of the first energy storage module 12a, and is in contact with the electrode-facing region A1 of the cathode-side end current collector foil 28 of the second energy storage module 12b. As a result, the cooling medium flows through the cooling channel 46a, so that the electrode-facing regions A1 of the two energy storage modules 12a, 12b in contact with the cooling plate 46 are cooled. The cooling plate 46 is electrically conductive. Therefore, the anode-side end current collector foil 32 of the first energy storage module 12a is electrically connected to the cathode-side end current collector foil 28 of the second energy storage module 12b via the cooling plate 46.

As illustrated in FIGS. 2 to 4, the energy storage device 10 further includes a plurality of adhesives 50. Each of the plurality of adhesives 50 has a frame shape. The adhesives 50 are stacked together with the two energy storage modules 12 in the Z-axis direction. That is, one of the adhesives 50 is disposed between the first energy storage module 12a and the upper wall 14a of the case 14. Another one of the adhesives 50 is disposed between the first energy storage module 12a and the second energy storage module 12b. Still another one of the adhesives 50 is disposed between the second energy storage module 12b and the lower wall 14c of the case 14.

Each of the adhesives 50 includes a base material 52 and two adhesive layers 54a, 54b. The two adhesive layers 54a, 54b include a first adhesive layer 54a and a second adhesive layer 54b. The first adhesive layer 54a is provided on one surface (in this example, the surface on the positive Z-axis direction side) of the base material 52. The second adhesive layer 54b is provided on the other surface (in this example, the surface on the negative Z-axis direction side) of the base material 52. The adhesive layers 54a, 54b are made of, for example, an epoxy-based resin, an acrylic-based resin, or a silicone-based resin. The adhesive strength of each adhesive layer 54a, 54b is, for example, 101 kPa or more. The adhesive strength of the adhesive layers 54a, 54b is a tensile adhesive strength measured in accordance with JIS K 6849 (1994). In addition, the adhesive layers 54a, 54b are less electrically conductive than the two current collector terminals 40, 42 and the cooling plate 46.

As shown in FIGS. 3 and 4, each adhesive 50 is disposed in the non-electrode-facing region A2 when viewed in the stacking direction. Note that each adhesive 50 may be disposed over the entire non-electrode-facing region A2 or may be disposed only in part of the non-electrode-facing region A2. As an example, each adhesive 50 in the present embodiment is disposed in a region including the center line CT in the non-electrode-facing region A2. The center line CT is a center line between the outer peripheral edge L1 of the electrode-facing region A1 and the inner peripheral edge L2 of the sealants 36, 38. As a result, the range of the non-electrode-facing region A2 of the cathode-side end current collector foil 28 of the first energy storage module 12a including the center line CT is bonded to the upper wall 14a of the case 14 via the adhesive 50. A range including the center line CT in the non-electrode-facing region A2 of the anode-side end current collector foil 32 of the first energy storage module 12a is defined as a first range. A range including the center line CT in the non-electrode-facing region A2 of the cathode-side end current collector foil 28 of the second energy storage module 12b is defined as a second range. The first range is bonded to the second range via the adhesive 50. In the non-electrode-facing region A2 of the anode-side end current collector foil 32 of the second energy storage module 12b, the range including the center line CT is bonded to the lower wall 14c of the case 14 via the adhesive 50.

In the energy storage device 10 described above, the non-electrode-facing region A2 of each of the end faces of the energy storage module 12 in the stacking direction is bonded to another adjacent energy storage module 12 or the case 14 via the adhesive 50. Each end face in the stacking direction of the energy storage module 12 is a surface on the positive Z-axis direction side of the cathode-side end current collector foil 28 and a surface on the negative Z-axis direction side of the anode-side end current collector foil 32. As described above, the non-electrode-facing region A2 of the energy storage module 12 are bonded to another adjacent energy storage module 12 or the case 14. Consequently, even when the pressure in the energy storage module 12 is reduced to a pressure lower than the atmospheric pressure, it is possible to avoid or suppress the non-electrode-facing region A2 from being recessed toward the inside of the energy storage module 12.

In the above-described embodiment, in each of the end faces of the energy storage module 12 in the stacking direction, the range of the non-electrode-facing region A2 that includes the center line CT is bonded to another adjacent energy storage module 12 or the case 14 via the adhesive 50. When the pressure in the energy storage module 12 is reduced, the non-electrode-facing region A2 tends to be recessed toward the inside of the energy storage module 12 particularly in the range including the center line CT. Therefore, the range including the center line CT is bonded to another adjacent energy storage module 12 or the case 14. This can effectively avoid or reduce the possibility that the non-electrode-facing region A2 may be recessed toward the inside of the energy storage module 12 even when the pressure in the energy storage module 12 is reduced to a pressure lower than the atmospheric pressure.

However, in each of the end faces of the energy storage module 12 in the stacking direction, the range including the center line CT may not be bonded to another adjacent energy storage module 12 or the case 14 via the adhesive 50. The range including the center line CT is a range of the non-electrode-facing region A2 that includes the center line CT between the outer peripheral edge L1 of the electrode-facing region A1 and the inner peripheral edge L2 of the sealants 36, 38. That is, in each of the end faces of the energy storage module 12 in the stacking direction, at least part of the non-electrode-facing region A2 may be bonded to another adjacent energy storage module 12 or the case 14 via the adhesive 50.

In the above-described embodiment, the energy storage device 10 includes two current collector terminals 40, 42 and a cooling plate 46. Each of the two current collector terminals 40, 42 and the cooling plate 46 is stacked together with the two energy storage modules 12 in the stacking direction. Each of the two current collector terminals 40, 42 and the cooling plate 46 is electrically conductive and is in contact with the electrode-facing region A1 of the end face of a corresponding energy storage module 12 in the stacking direction. According to such a configuration, the cathode-side end current collector foil 28 of the first energy storage module 12a and the anode-side end current collector foil 32 of the second energy storage module 12b are electrically connected to each other via one of the two current collector terminals 40, 42 and the cooling plate 46. In this case, since the adhesive 50 is disposed around each of the two current collector terminals 40, 42 and the cooling plate 46, the thickness of the adhesive 50 may be designed to match the thickness of each of the two current collector terminals 40, 42 and the cooling plate 46.

Note that each of the two current collector terminals 40, 42 and the cooling plate 46 in the present embodiment is an example of a plate material in the present technology. Note that the energy storage device 10 may not include all of the two current collector terminals 40, 42 and the cooling plate 46. That is, the energy storage device 10 may include at least one of the two current collector terminals 40, 42 and the cooling plate 46.

In the above embodiment, the cooling plate 46 is provided with the cooling channel 46a through which a cooling medium flows. According to such a configuration, the cooling plate 46 can cool the energy storage module 12 in contact with the cooling plate 46.

In other embodiments, the energy storage device 10 may include a connection plate instead of the cooling plate 46. The connecting plate has the same configuration as the cooling plate 46 except that the cooling channel 46a is not provided. That is, the connecting plate is electrically conductive. The connecting plate is in contact with the electrode-facing region A1 of the anode-side end current collector foil 32 of the first energy storage module 12a and is in contact with the electrode-facing region A1 of the cathode-side end current collector foil 28 of the second energy storage module 12b. Thus, the anode-side end current collector foil 32 of the first energy storage module 12a is electrically connected to the cathode-side end current collector foil 28 of the second energy storage module 12b via the connecting plate. The connecting plate in this embodiment is also an example of a plate material in the present technology.

In the above embodiment, the adhesive 50 includes a base material 52 in the form of a sheet and adhesive layers 54a, 54b provided on both surfaces (here, the surface on the positive Z-axis direction side and the surface on the negative Z-axis direction side) of the base material 52. According to such a configuration, for example, the thickness of the base material 52 and the thicknesses of the adhesive layers 54a, 54b can be changed as appropriate according to the distance between the electrode-facing regions A1 of two adjacent energy storage modules 12. However, each of the adhesives 50 may not include the base material 52. In other embodiments, each adhesive 50 may be comprised of a single layer of adhesive.

In the above embodiment, the energy storage device 10 includes two energy storage modules 12. However, the number of energy storage modules 12 is not limited to two, and may be any number as long as it is at least one. For example, when the number of energy storage modules 12 is one, at least part of the non-electrode-facing region A2 of each end face of the energy storage module 12 in the stacking direction may be bonded to the case 14 via the adhesive 50. Alternatively, when the number of energy storage modules 12 is three or more, at least part of the non-electrode-facing region A2 of each end face of each energy storage module 12 in the stacking direction may be bonded to another adjacent energy storage module 12 via the adhesive 50. In this case, the cooling plate 46 (or the connection plate described above) may be provided between adjacent energy storage modules 12.

In the above-described embodiment, the electrode sheets 16, 18, 20 include one bipolar electrode sheet 16, a cathode-side end electrode sheet 18, and an anode-side end electrode sheet 20. However, the number of bipolar electrode sheets 16 is not limited to one, and may be any number as long as it is at least one. That is, in other embodiments, the electrode sheets 16, 18, 20 may include two or more bipolar electrode sheets 16, a cathode-side end electrode sheet 18, and an anode-side end electrode sheet 20.

While several specific examples have been described in detail above, these are merely illustrative and do not limit the scope of the claims. Various modifications and variations of the specific examples described above are included in the technology described in the claims. The technical elements described in this specification or in the drawings may be used alone or in combination to achieve technical usefulness.

What is claimed is:

1. An energy storage device comprising:
at least one energy storage module stacked in a first direction; and
a case that houses the at least one energy storage module, wherein:
each of the at least one energy storage module includes
a plurality of electrode sheets stacked in the first direction and including a bipolar electrode sheet, and
a sealant disposed at a periphery of the electrode sheets and sealing an electrolyte between the electrode sheets;
the bipolar electrode sheet includes a current collector foil, a cathode active material layer provided on one surface of the current collector foil, and an anode active material layer provided on another surface of the current collector foil;
each of end faces of the energy storage module in the first direction includes an electrode-facing region and a non-electrode-facing region, the electrode-facing region facing either or both of the cathode active material layer and the anode active material layer when viewed in the first direction, and the non-electrode-facing region being located outward of the electrode-facing region and inward of the sealant when viewed in the first direction; and
in each of the end faces of the energy storage module in the first direction, at least part of the non-electrode-facing region is bonded to another adjacent energy storage module or the case via an adhesive.

2. The energy storage device according to claim 1, wherein, in each of the end faces of the energy storage module in the first direction, a range of the non-electrode-facing region that includes a center line between an outer peripheral edge of the electrode-facing region and an inner peripheral edge of the sealant is bonded to the other adjacent energy storage module or the case via the adhesive.

3. The energy storage device according to claim 1, further comprising at least one plate material stacked together with the at least one energy storage module in the first direction,
wherein each of the at least one plate material is electrically conductive and is in contact with the electrode-facing region of the end face of the energy storage module in the first direction.

4. The energy storage device according to claim 3, wherein the plate material is provided with a cooling channel through which a cooling medium flows.

5. The energy storage device according to claim 1, wherein the adhesive includes a base material in a form of a sheet, and an adhesive layer provided on each of both surfaces of the base material.
